(19) United States
(12) Patent Application Publication
(10) Pub. No.: US 2022/0237526 A1
(43) Pub. Date: Jul. 28, 2022

(54) METHOD AND APPARATUS FOR A UNIVERSAL CONNECT CORPORATE TRAVEL MANAGEMENT PLATFORM

(71) Applicant: nuTravel Technology Solutions, Inc., Purchase, NY (US)

(72) Inventors: Carmine Carpanzano, Purchase, NY (US); Joseph Sternlicht, Purchase, NY (US); Paul LaBate, Purchase, NY (US); Rich Hunt, Purchase, NY (US)

(21) Appl. No.: 17/478,082

(22) Filed: Sep. 17, 2021

Related U.S. Application Data
(60) Provisional application No. 63/080,912, filed on Sep. 21, 2020.

(51) Int. Cl. G06Q 10/02; G06Q 10/10; G06Q 40/02

(52) U.S. Cl. CPC G06Q 10/02; G06Q 40/02; G06Q 10/109

(57) ABSTRACT

A travel management system and method for enabling travelers to directly book, track, and analyze the business travel is disclosed. The system refers to a platform that offers features such as onboarding process, travel inventory, travel policies, reservations, travel advisories, and reporting, and also refer to the overall process of managing corporate travel. The system comprises a computing device having a memory and a processor, wherein the computing device is in communication with a server via a network. A database in communication with the server is configured to store data related to travelers, travel managers, companies, travel providers or airlines, and the corporate travel. The database comprises modules include a login module, an application program interface (API), a data sharing module or a transceiver, and an admin module. The system is further configured to enable and allow travel managers to properly capture, track, and control the budget of their travelers.

### PRIOR PROVISIONAL APPLICATION

The present application claims the benefit of U.S. Provisional Application Ser. No. 63/080,912, filed Sep. 21, 2020 (and the Appendixes/Attachments filed therewith), the disclosures of each of which are hereby incorporated by reference.

### FIELD OF THE INVENTION

The present invention relates generally to a travel management system and method, and more specifically, to a corporate travel management system and method for travel managers to manage, track, and analyze their company's business travel through the sharing of corporate travel management data between travel providers and the Universal Connect system to allow travel providers to offer a corporate booking experience on their booking platforms to the corporate travelers.

### BACKGROUND OF THE INVENTION

Over the past years both business and personal travel has been increasing at a dramatic rate. In order to accommodate and facilitate the increased travel being made by both business and personal travelers, whether by air, train, ship, bus, limousine and other modes of transportation, much time, effort, and resources have been spent on an ongoing basis by the travel industry. The travel industry includes airlines, charter services, airports, helicopter operators, travel managers and agents, railroads, cruise lines, limousine companies, government entities, and so forth.

It is important to the travel industry as a whole, and particularly to the airline industry, to provide a user-friendly, secure, and rapid response reservation and travel planning system. Such efforts have led the travel industry to make extensive use of the Internet, for permitting travelers to make numerous travel arrangements and plans through use of their personal computer linked to the Internet to access a desired travel related website.

Currently, travelers have many problems to directly book and reserve business travel. Airlines could reduce and/or cut down the distribution costs and have more control over the user experience by offering direct booking, but they are not able to identify business travelers nor keep travel managers happy by offering them control and travel tracking due to current limitations. Travel managers want to enforce their corporate policy, ensure their hard-fought negotiated rates are being applied, and they want to make sure their travelers are being tracked when they are on the road. They also want to save money and to avoid booking fees imposed by traditional channels. However, travelers want to have the ability to easily use the software applications that are already exist on their phones or the website of their favorite airline to book all of their trips, both personal and business travels. The existing systems in the market today that help capture direct spend after the trip has been booked, but none that offer a truly universal platform that allows travel managers to control their traveler's budget.

Business travelers prefer to book directly with suppliers but are typically steered away by their travel managers. Instead, they are required to continue to book directly with booking tools that are subpar or unsatisfactory to their leisure counterparts. This is mainly due to the travel managers inability to properly capture, track, and control travel that is purchased outside of their existing booking tools. There are products in the market today that help capture direct spend after the trip has been booked, but none that offer a truly universal platform that allows travel managers to control their traveler's budget. For airlines, they would much prefer to have travelers come directly to them to book. It allows them to deliver an experience tailored to a high-end segment of the market while only costing them a fraction of what it would if that traveler booked through a traditional corporate booking channel. Therefore, there is a need for a solution to remove these barriers between the airlines, travel managers, and travelers.

In light of the above-mentioned problems, there is a need for a travel management system and method for enabling travelers or business travelers to directly book, track, and analyze the business travel or corporate travel. There is also a need for a travel management system for enabling and allowing the travel managers to properly capture, track, and control their traveler's budget. There is also a need for a travel management system for airlines in order to enable travelers for directly booking the business or corporate travel. Further, there is also a need for a travel management system that refers to a platform and offers features such as, but not limited to, onboarding process, travel inventory, travel policies, reservations, travel advisories, and reporting, and could also refer to the overall process of managing corporate travel.

### SUMMARY OF THE INVENTION

The present invention generally discloses a travel management system and method. Further, the present invention discloses a travel management system and method for enabling travel managers to manage, track, and analyze their company's business travel through the sharing of corporate travel management data between travel providers and Universal Connect to allow travel providers to offer a corporate booking experience on their booking platforms to the corporate travelers. The travel management system also offers features such as, but not limited to, onboarding process, travel inventory, travel policies, reservations, travel advisories, and reporting.

In one embodiment, the system is configured to enable travel managers or business travelers to directly book, track, and analyze the business travel or corporate travel with suppliers using the user device. In one embodiment, the system is further configured to enable and allow travel managers to properly capture, track, and control the budget of their travelers. In one embodiment, the system is further configured to enable travel providers in order to allow travelers for directly booking the business or corporate travel. In one embodiment, the system is configured to provide experience tailored to a high-end segment for the travelers by enabling to directly book a corporate travel and also provide offers for the travel managers by enabling them to control and track the corporate travel.

In one embodiment, the system comprises an intuitive travel management interface. In one embodiment, the system is simple and clean yet robust enough for companies of all sizes to effectively use. In one embodiment, the system enables the travelers and end customers to register, connect their airline loyalty or other account programs they have with their airlines to their company, and directly book corporate travel seamlessly and without any difficulty.

In one embodiment, the system refers to a platform or an application and offers different features such as, but not limited to, onboarding process, travel inventory, travel policies, reservations, travel advisories, and reporting, and could also refer to the overall process of managing corporate travel. The system has the ability to take in and share data in order to be able to fit within the travel manager's programs.

In one embodiment, the system comprises a computing device having a memory and a processor, wherein the computing device is in communication with a server via a network. In one embodiment, a database in communication with the server is configured to store data related to, but not limited to, users or travelers, travel managers, companies, travel providers or travel agencies, and the corporate travel. In one embodiment, the database comprises one or more modules include, but not limited to, a login module, an application program interface (API), a data sharing module or a transceiver, and an admin module.

In one embodiment, the travelers could register for accessing the system via the admin module using a user device. In one embodiment, admins of the system are able to initiate and perform various functions in accordance with a registration system using a user device.

In one embodiment, the user device is configured to access the services provided by the system's server. User devices further have the capability to provide the user an interface to interact with the services provided by the system. User devices such as, but not limited to, a desktop computer, a laptop computer, a smartphone, a computer tablet, and the like. User devices may execute one or more client applications such as, without limitation, a web browser to access and view content over a computer network, an email client to send and retrieve emails, an instant messaging client for communicating with other users, and a File Transfer Protocol (FTP) client for file transfer. User devices, in various embodiments, may include a Wireless Application Protocol (WAP) browser or other wireless or mobile device protocol suites.

Network generally represents one or more interconnected networks, over which the user devices and server can communicate with each other. In one embodiment, the network could be, but not limited to, packet-based wide area networks (such as the Internet), local area networks (LAN), private networks, wireless networks, satellite networks, cellular networks, paging networks, and the like. For example, network may be a combination of a LAN and the Internet. In addition, network may be implemented as a wired network, or a wireless network or a combination thereof.

In one embodiment, one or more travel providers such as, but not limited to, airlines and rails are connected to the system via the application program interface (API) and other web services. In one embodiment, one or more hotels are also connected to the system via the application program interface. In one embodiment, the travelers could be connected to the one or more travel providers (e.g., airlines, hotels, car rental, train, etc.) by selection, thereby enabling the travelers to directly book their corporate travel. In one embodiment, the data sharing module or a transceiver is configured to share or transfer data related to the corporate travel to one or more expense providers, duty of care (DoC), travel management center (TMC), Itinerary Management Systems, digital wallets, etc.

In one embodiment, the modules are executed by the processor, configured to perform different operations includes, but not limited to, enabling the travelers or business travelers to directly book, track, and analyze the business travel or corporate travel with suppliers, thereby providing experience tailored to a high-end segment for the travelers, allowing the travel managers to properly capture, track the corporate travel, and control the budget of their travelers, enabling airlines in order to allow travelers for directly book the business or corporate travel, and providing onboarding process, travel inventory, travel policies, reservations, travel advisories, reporting, and other corporate management functionality for the overall process of managing corporate travel.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a travel management system in an embodiment of the present invention.

FIG. 2 shows a screenshot of an example of a login page on a user node in one embodiment of the present invention.

FIG. 3 shows a screenshot illustrates various register travel providers for the user or traveler to choose or select for booking a corporate travel in one embodiment of the present invention.

FIG. 4 shows a screenshot illustrates available and connected travel providers in one embodiment of the present invention.

FIG. 5A shows a schematic diagram of a universal connect data creation or phases of data collection and creation for the travel management system (Universal Connect) in one embodiment of the present invention.

FIG. 5B shows a schematic diagram of a universal connect data creation or phases of data collection and creation for the travel management system (Universal Connect) in one embodiment of the present invention.

FIG. 5C shows a schematic diagram of a universal connect data creation or phases of data collection and creation for the travel management system (Universal Connect) in one embodiment of the present invention.

FIG. 6 shows a schematic diagram of the flow and calls to and from the travel provider, Universal Connect and data share providers in one embodiment of the present invention.

FIG. 7 shows a schematic diagram of the system with service providers in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

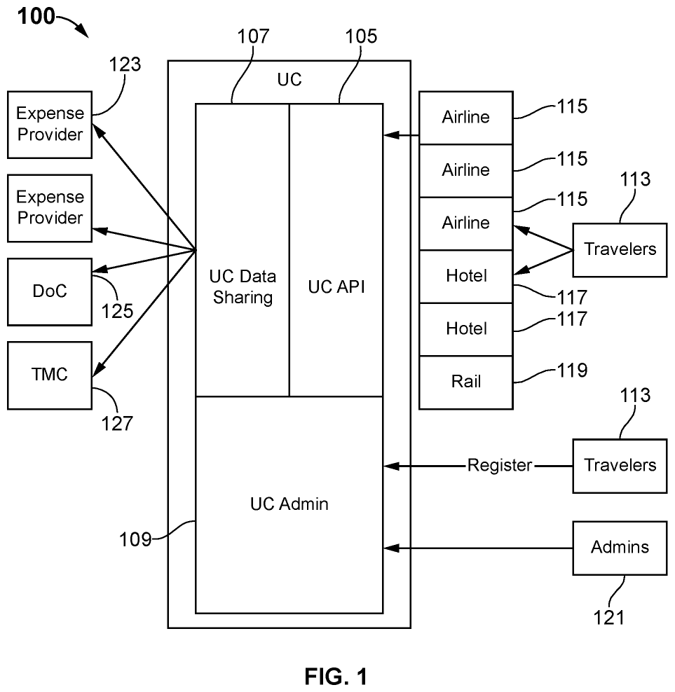

Referring to FIG. 1, a block diagram of a travel management system 100 in one embodiment is disclosed. In one embodiment, the system 100 enables travelers 113 and end users for directly booking, tracking, and analyzing the business travel using a user device, for example, a smartphone. In one embodiment, the system 100 refers to a platform that offers features such as, but not limited to, onboarding process, travel inventory, travel policies, reservations, travel advisories, and reporting, and could also refer to the overall process of managing corporate travel.

In one embodiment, the system 100 is configured to enable travelers 113 or business travelers to directly book, track, and analyze the business travel or corporate travel with suppliers using the user device. In one embodiment, the system 100 is further configured to enable and allow travel managers to properly capture, track, and control the budget of their travelers 113. In one embodiment, the system 100 is further configured to enable airlines in order to allow travelers 113 for directly booking the business or corporate travel. In one embodiment, the system 100 is configured to provide experience tailored to a high-end segment for the travelers 113 by enabling to directly book a corporate travel and also provide offers for the travel managers by enabling them to control and tracking the corporate travel.

In one embodiment, the system 100 comprises an intuitive travel management interface. In one embodiment, the system 100 is simple and clean yet robust enough for companies of all sizes to effectively use. In one embodiment, the system 100 enables the travelers 113 and end customers to register, connect their loyalty or account programs they have with travel providers (e.g., airlines, hotels, car rental, train, etc.) to their company, and directly book their corporate travel seamlessly and without any difficulty. In such manner the system 100 allows the travelers 113 to book directly on the airlines website or mobile app while being recognized as a business traveler for the registered company.

In one embodiment, the system 100 refers to a platform or an application and offers different features such as, but not limited to: onboarding process; tracking of travel inventory; travel policies; viewing of reservation details; travel advisories; and reporting; and could also refer to the overall process of managing corporate travel. The system 100 has the ability to take in and share data in order to be able to fit within the travel managers program.

In one embodiment, the system 100 comprises a computing device having a memory and a processor, wherein the computing device is in communication with a server via a network. In one embodiment, a database in communication with the server is configured to store data related to, but not limited to, users or travelers 113, travel managers, companies, travel providers or airlines, and the corporate travel. In one embodiment, the database comprises one or more modules include, but not limited to, a login module, an application program interface (API) 105, a data sharing module or a transceiver 107, and an admin module 109.

In one embodiment, the travelers 113 could register for accessing the system 100 via the admin module 109 using a user device. In one embodiment, admins 121 of the system 100 are able to initiate and perform various functions in accordance with a registration system using the user device.

In one embodiment, the user device is configured to access the services provided by the system's server. User devices further have the capability to provide the user an interface to interact with the services provided by the system 100. User devices such as, but not limited to, a desktop computer, a laptop computer, a mobile phone, a personal digital assistant, and the like. User devices may execute one or more client applications such as, without limitation, a web browser to access and view content over a computer network, an email client to send and retrieve emails, an instant messaging client for communicating with other users, and a File Transfer Protocol (FTP) client for file transfer. User devices, in various embodiments, may include a Wireless Application Protocol (WAP) browser or other wireless or mobile device protocol suites.

Network generally represents one or more interconnected networks, over which the user devices and server can communicate with each other. In one embodiment, the network could be, but not limited to, packet-based wide area networks (such as the Internet), local area networks (LAN), private networks, wireless networks, satellite networks, cellular networks, paging networks, and the like. For example, network may be a combination of a LAN and the Internet. In addition, network may be implemented as a wired network, or a wireless network or a combination thereof.

In one embodiment, one or more travel providers such as, but not limited to, airlines 115 and rail providers 119 (as well as hotel reservations and automobile rentals) are connected to the system 100 via the application program interface (API) 105. In one embodiment, one or more hotel providers 117 are also connected to the system 100 via the application program interface 105. In one embodiment, the travelers 113 could be connected to the one or more airlines by selecting, thereby enabling the travelers 113 to directly book a corporate travel. In one embodiment, the data sharing module or a transceiver 107 is configured to share or transfer data related to the corporate travel to one or more expense providers 123, duty of care (DoC) 125, and also travel management center (TMC) 127.

In one embodiment, the modules are executed by the processor, configured to perform different operations includes, but not limited to, enabling the travelers 113 or business travelers to directly book, track, and analyze the business travel or corporate travel with suppliers, thereby providing experience tailored to a high-end segment for the travelers, allowing the travel managers to properly capture, track the corporate travel, and control the budget of their travelers, enabling airlines in order to allow travelers 113 for directly booking the business or corporate travel on the airline's website/mobile app, and providing onboarding process, travel inventory, travel policies, viewing of reservations, travel advisories, reporting, and overall process of managing corporate travel.

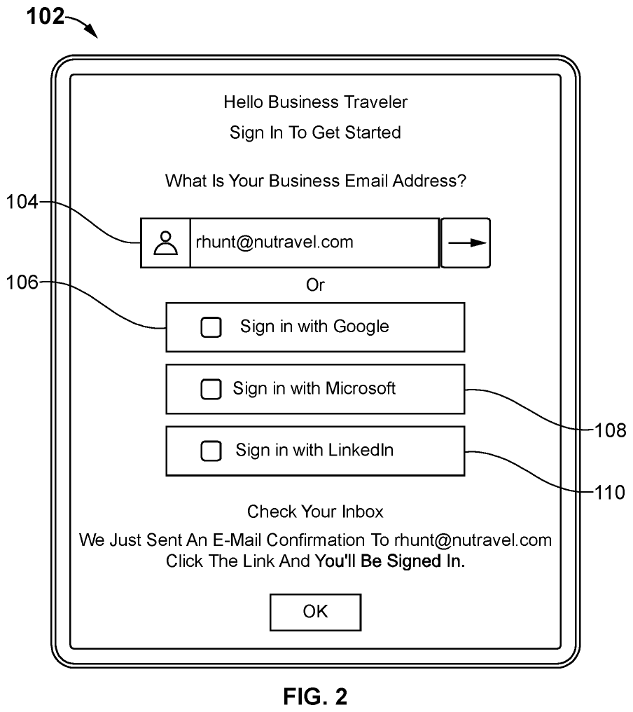

Referring to FIG. 2, a screenshot 102 of an example of a login page on a user node in one embodiment is disclosed. In one embodiment, the system 100 enables the travelers 113 (shown in FIG. 1) and end customers to register for creating an account, connect their travel programs to travel providers, and directly book a corporate travel seamlessly and without any difficulty. In one embodiment, the system 100 enables the user or traveler to register by providing credentials such as, but not limited to, user name, email, mobile number, etc. In one embodiment, the user could login into the system 100 by entering the credentials such as a user ID and password on the respective icons 104. In one embodiment, the system 100 comprises a login module and a password module, which are configured to control access to the application for the valid users or account holders.

In one embodiment, the user or traveler could directly login into the system 100 via, but not limited to, a Google account 106, a Microsoft account 108, and also via a LinkedIn account 110. In one embodiment, the system 100 is further configured to confirm the user by sending an e-mail confirmation to the registered email so that the user could sign in into the system 100.

In one embodiment, the system 100 comprises an intuitive travel management interface. In one embodiment, the system 100 is simple and clean yet robust enough for companies of all sizes to effectively use. The system 100 enables the travelers 113 and end customers to register, connect their travel programs to airlines, and directly book a corporate travel without any difficult and flawless.

In one embodiment, the system 100 refers to a platform and offers different features such as, but not limited to, onboarding process, travel inventory, travel policies, reservations, travel advisories, and reporting, and could also refer to the overall process of managing corporate travel. The system 100 has the ability to take in and share data in order to be able to fit within the travel managers program.

In one embodiment, the travelers 113 who are added/invited/join using their corporate email address will have the ability to view all of the travel providers that are registered/activated by their travel manager and will be able to link their personal loyalty accounts with each of those airlines to their companies universal connect account. This will create the link needed for the airlines to recognize them as a corporate traveler and allow them to retrieve the corporate profile from us in order to deliver the corporate booking experience on their websites/mobile applications to the traveler.

In one embodiment, the system 100 is further configured to send invitations to the travelers 113 and end users via e-mails. The travelers 113 and end users could accept the invitation for registering and joining via the platform. In one embodiment, the system 100 could verify the travelers 113 with corporate e-mail and thereafter a magic link will send a corporate e-mail or OAuth verification to the traveler and end user. In one embodiment, the travelers 113 could sign in with their e-mail and password. In one embodiment, the travelers 113 could sign in with Google/Microsoft via OAuth to bypass the verification. Alternatively, in one embodiment there is an SSO/SAML option for larger companies where travelers 113 can sign in using their company credentials fully integrated via identity management providers (e.g., Microsoft azure, okta, Google g-suite, Microsoft ADFS). In one embodiment, the system 100 is further configured to provide an interface for each airline for the travelers 113 and end users for providing their credentials to activate travel providers for directly booking business travel. In one embodiment, the United airlines have different programs, for example, a MileagePlus program that makes it easy to earn and use award miles on the purchases every day, from flights and hotel stays to car rentals and more. In one embodiment, the American airlines have different programs, for example, an AAdvantage program that provides upgrades, bonus miles, airport privileges and more for the traveler. In one embodiment, the southwest airlines have different programs, for example, rapid rewards program that offer points for every dollar spent on southwest flights.

In one embodiment, the travel managers could access the system 100 directly on a a nuTravel hosted URL. This will be a public URL that matches the platform branding and trademarked. This will also be the entryway URL for new companies looking to register. In one embodiment, the travelers 113 could access a traveler profile site where they could view and manage their connections to the various airlines that the company has registered for.

In one embodiment, the travel manager could login directly into the system 100 via a universal connect admin (ex. uc.nutravel.com) using the platform (universal connect admin platform). In one embodiment, the travel manager could login using a magic link or OAuth with a corporation e-mail (ex. uc.nutravel.com/travel). In one embodiment, traveler manager could log in via email/password, OAuth or SSO. The travelers 113 could manage their profile and the airlines that are connected on universal connect traveler page after e-mail validation. In one embodiment, the travelers 113 could go to each connected airline in order to book their business flights. Each airline will show a profile switcher, for example, AA.com, United.com, Southwest.com, etc. for the traveler to switch from personal to business.

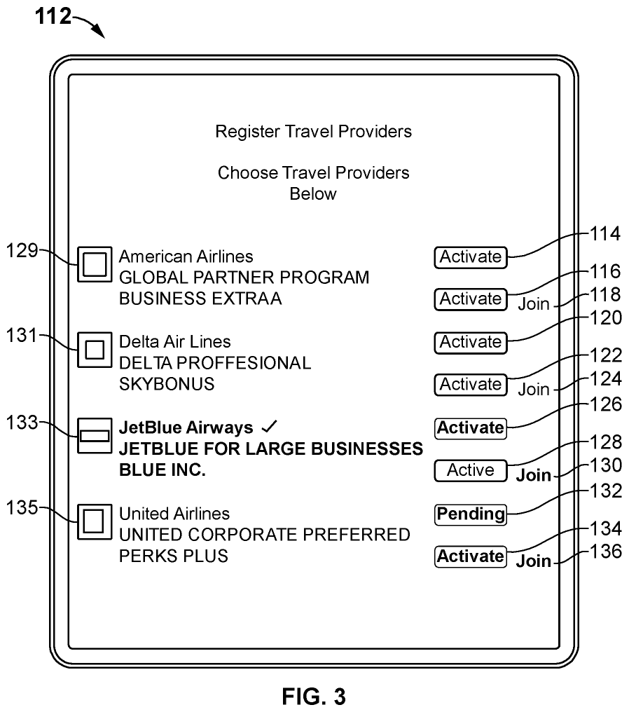

Referring to FIG. 3, a screenshot 112 illustrates various register travel providers for the user or traveler to choose or select for booking a corporate travel in one embodiment is disclosed. In one embodiment, the user could select at least any one or more travel providers such as, but not limited to, American airlines 129, Delta Air lines 131, JetBlue Airways 133, and United airlines 135. In an exemplary embodiment, the user could select the American airlines 129 by joining 118 and also activate at least any of a service include, but not limited, global partner program and business extra by clicking or selecting activate icons (114 and 116), respectively. In yet another exemplary embodiment, the user could select the Delta Air lines 131 by joining 124 and also activate at least any of a service include, but not limited, delta professional and skybonus by clicking or selecting the activate icons (120 and 122), respectively. In yet another exemplary embodiment, the user could select the JetBlue Airways 133 by joining 130 and also activate at least any of a service include, but not limited, JetBlue for large business and BLUE INC. by clicking or selecting the activate icons (126 and 128), respectively.

In yet another exemplary embodiment, the user could select the United airlines 135 by joining 136 and also activate at least any of a service include, but not limited, united corporate preferred and perks plus by clicking or selecting the activate icons (132 and 134), respectively.

In one embodiment, the system 100 refers to an intuitive travel management platform for companies of different sizes. In one embodiment, the system 100 includes corporate activation that comprises a build registration process for corporation(s) to connect to the system 100 and also includes define custom program registration process(es) for corporate(s) to connect multiple airlines. In one embodiment, the system 100 further includes a cross platform user interface (UI) to implement core user/group management features, build policies and payment manager that works across the airlines, implement flight board and traveler activity visualizations, define traveler invite/onboarding options, and also build onboarding and support tools.

In one embodiment, the system 100 could provide an easy traveler experience to join Universal Connect and link to various airlines for booking, develop onboarding experience for travelers 113 using an invite/corporate email, and also implement an easy process to activate each airline in one place.

In one embodiment, the platform of the system 100 is connected to application program interfaces (APIs) for developing standard APIs to communicate with the airlines and also defining documentation and onboarding for the airlines. In one embodiment, the platform of the system 100 is further connected to a third-party connectivity for implementing DOC provider connections and expense provider connections, and also implementing connectivity to flight status providers.

In one embodiment, the system 100 is further configured to allow the traveler managers to freely register and join via the platform for booking corporate travel. The system 100 allows the travel managers to view the registered and participating airlines and also register and connect individually with each airline by joining and activating each airline in their account via the platform. In one embodiment, each airline has one or more registration paths for the company to sign-up, for example, Delta Air lines 131 has service paths include, but not limited, delta professional, skybonus OA SME companies, and large contracted accounts. At any time, the travel manager can disconnect one of the airline partners.

In one embodiment, the participating airlines such as United airlines, American airlines, and Southwest airlines could have one or more registration flows to maintain their current business programs. In one embodiment, United airlines could have a contracted resignation and a SMB registration and the American airlines could have an extra registration and a contracted registration. In one embodiment, the Southwest airlines could have a SWABIZ registration and a contracted resignation. The travel managers could register for only one program per each airline. After successful completion of registration, the airline is activated for the company.

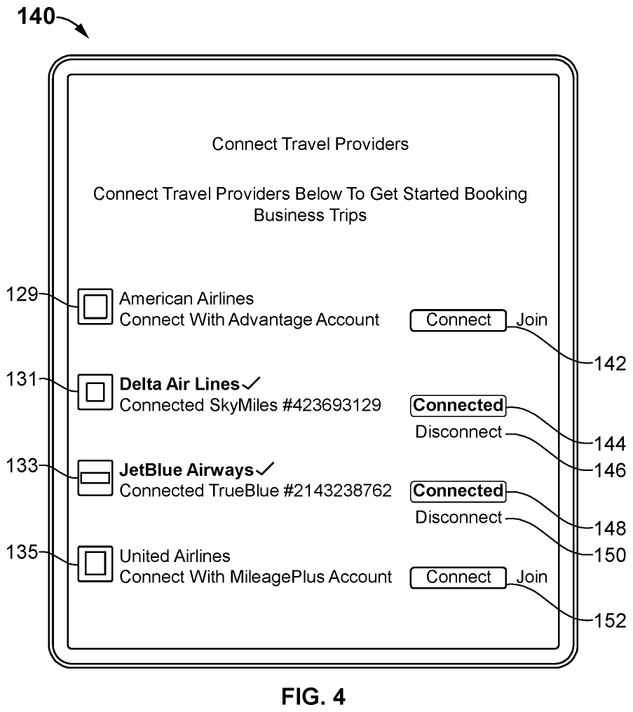

Referring to FIG. 4, a screenshot 140 illustrates available and connected travel providers in one embodiment is disclosed. In one embodiment, the user could connect to one or more travel providers such as, but not limited to, American airlines 129, Delta Air lines 131, JetBlue Airways 133, and United airlines 135 by joining and connecting using connect icons (142, 144, 148, and 152) in order to get start booking business trips. In one embodiment, the user could also disconnect the connected travel provider, for example, Delta Air lines 131 and/or JetBlue Airways 133 if the user already connected to the travel providers by clicking on disconnect icons (146 and 150), respectively.

In one embodiment, each participating travel provider or airline will be required to adopt a standardized set of nuTravel APIs in order to retrieve data from the system's server and post bookings back. A detailed set of API documentation is attached hereto. All main features like traveler profile, policy, payment, and booking data should be standardized and will be required to be adopted by each airline who participates. This will ensure that there is no confusion to corporate travel managers who sign up what features are offered by which airlines.

In one embodiment, aside from custom registration flows, certain airlines do have specific offers and products that are not consistent across each airline. As an example, Southwest Airlines has a “wanna get away” fare that does not neatly fit into a general policy manager in order to control traveler access. In this case there could be a custom setting for Southwest Airlines where the travel manager can toggle access to these fares on or off. In scenarios like these the travel manager will be able to view a set of specific airline settings under each of the airline partners. This gives airlines flexibility with their unique offerings while keeping them out of the core UI elements like policy manager.

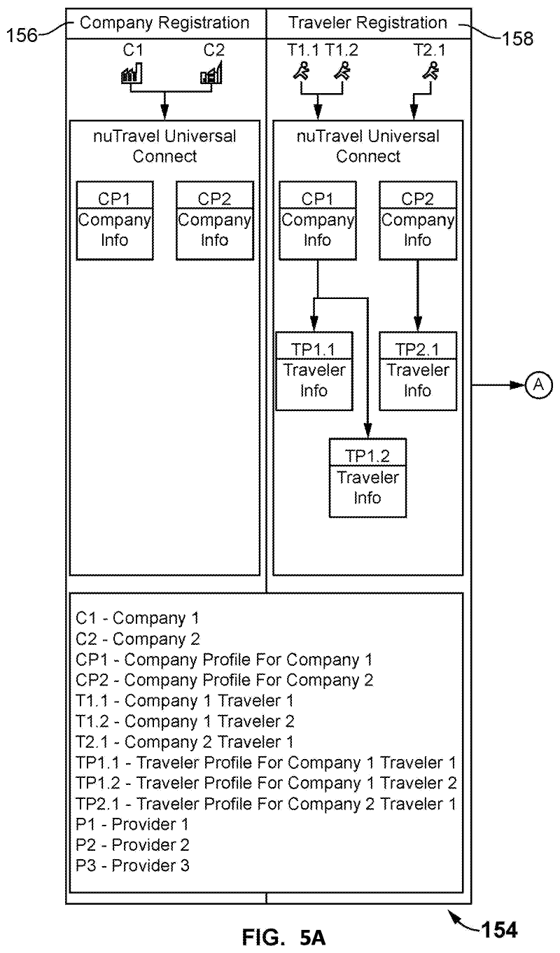

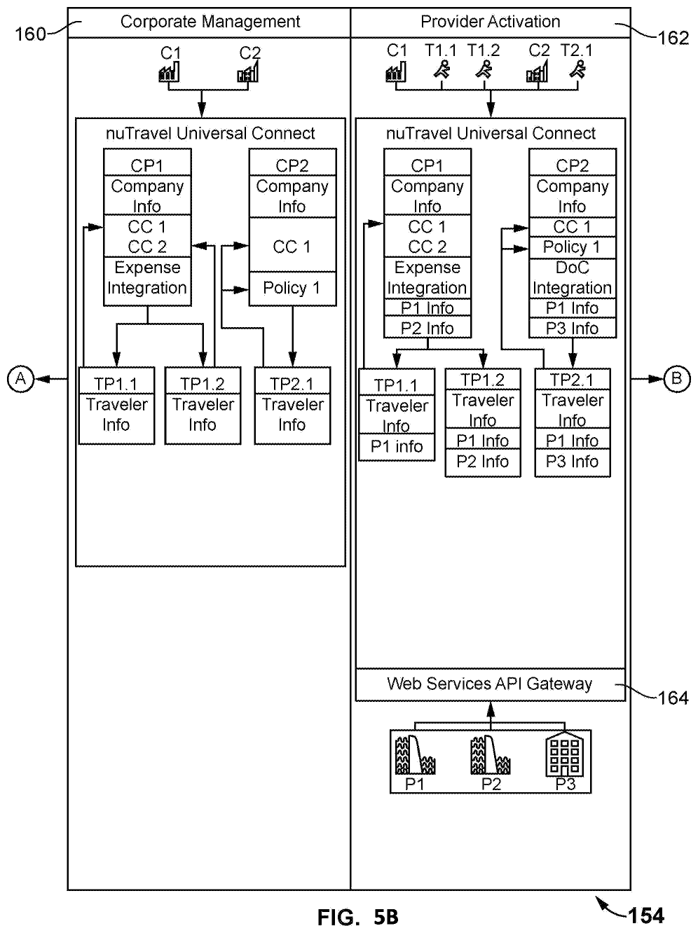

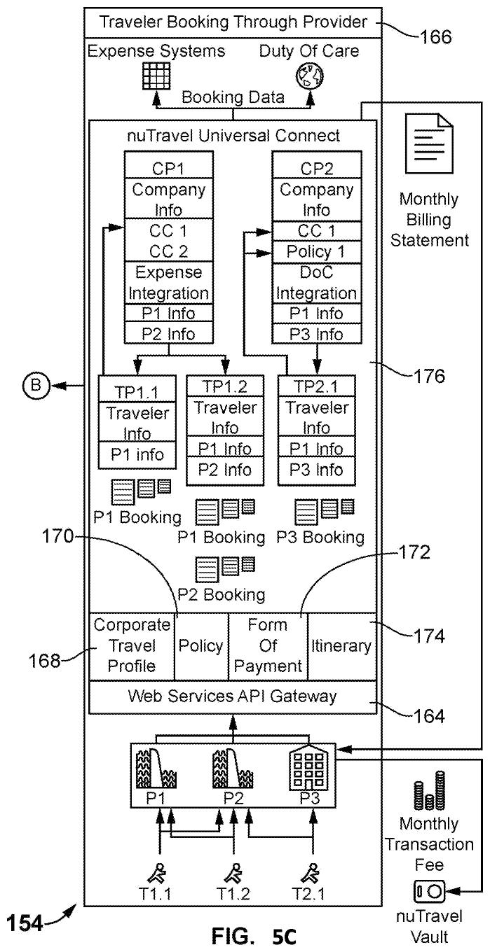

Referring to FIG. 5, a universal connect data creation or phases of data collection and creation for the system 100 (Universal Connect) in one embodiment is disclosed. In one embodiment, the system 100 includes a database for collecting and storing data related to travelers 113, travel managers, companies, travel providers or airlines, and corporate travel information, etc. In one embodiment, the data related to company contains some basic information about the company such as, but not limited to, name, address, contact information for the administrator, tax ID, and some descriptive information such as size, industry, etc. This information is collected when a company signs up to use the system 100 (Universal Connect). If the company registers with the system 100 (Universal Connect) i.e., company registration 156 they have to provide some basic information and this could be securely stored in the system's database.

In one embodiment, the data related to traveler contains some basic information such as, but not limited to, name and e-mail, perhaps phone and an employee number. This information is collected when the traveler accepts an invitation from the company administrator and signs up. They will also create a password or they can log in via Oauth if the administrator has set their company up as such or via SSO with a configured IDP (identity provider - okta, azure, ADFS, G-suite . . . ). If the travelers 113 register with the system 100 (Universal Connect) i.e., traveler registration 158 then they have to provide some basic information and this could be securely stored in the system's database. In one embodiment, the corporate administrator could perform management activities i.e., corporate management 160 of the company in the system 100 (Universal Connect) and also create groups for users and add corporate credit cards and travel policies then assigning them to travelers 113.

When the corporate administrator activates a provider (airline, hotel, etc) i.e., provider activation 162, more data is collected that is specific to the provider such as a corporate customer number, corporate contract, or other such loyalty or program information that will be used to identify and, in some cases, authenticate the company. This data is stored in the database of the system 100 (Universal Connect) as provider information and shared with the provider(s) via, but not limited to, a web services API gateway 164. Once a provider is activated, travelers 113 in that company can activate their personal connection with that provider(s) by sharing data with the provider such as their loyalty number. Authentication of the traveler (logging in) with the provider may be required for activating and sharing data with the provider.

When a traveler goes to the provider's website i.e., traveler booking trough provider 166 to make a business booking (as opposed to a leisure booking), the provider will use the web services API gateway 164 to request the system 100 (Universal Connect) for the corporate travel profile 168 for the traveler. In one embodiment, nuTravel 176 could respond by returning the company information, the provider information that is collected when the company activated that provider, the traveler information, and the provider information for that traveler. This will allow the provider to customize the user experience for the business traveler. After, the provider may ask for the policy information for that traveler if there is a policy 170 assigned to the traveler and nuTravel 176 will return it so the provider could show inventory as in or out of policy.

If the traveler decides to book then the provider will ask for forms of payment 172 associated with the traveler and the nuTravel 176 will return the credit card information, which is assigned by the corporate administrator for the traveler.

If the traveler makes a booking then the provider will send the booking back to the nuTravel 176 so it can be stored in the system 100 (Universal Connect) and the travel managers for the company can view and manage the bookings made by their travelers 113. If the company set up integration with data exchange providers, such as expense or duty of care providers, then the system 100 (Universal Connect) will also share that data with the providers as instructed by the corporate administrator and also share an itinerary 174 for the travelers 113. Monthly, the nuTravel 176 will export an accounting of the bookings and send proof of activity to the providers for a usage fee to be collected.

In one embodiment, the travel manager provides company details to the nuTravel 176. The data related to the travel manager include name, company name, address, phone or contact number, e-mail, and website. The data related to company such as name, phone or contact number, e-mail, and size of the company are accepted and stored within the system's database. The data related to the company could be transmitted and sent to the airlines and travel providers when the company activates the provider.

In one embodiment, the data accepted to be sent to the airline will be unique for each airline. In one embodiment, form data will be submitted to the airline and possibly stored by the airline. In one embodiment, the airlines may use the data to validate against their existing CRM system or database. The data could be exchanged back to the nuTravel 176 about the company and stored (such as a discount rate code or special identifier required for bookings). Any unique datapoints are required by the airline to send to airline systems for verification.

In one embodiment, the system 100 is further configured to send invitations for travelers and agencies. At one stage, the administrator user could login into the system 100 (Universal connect) with credentials such as a user ID and a password. After successful completion of log in, select the company to manage and add people by selecting. In one embodiment, the travel managers could invite travelers through a number of mechanisms include, but not limited to, trigger an invite e-mail, share a link or add their corporate email domain to the system 100 (Universal connect) so that travelers who can validate that they have an e-mail address at that domain can join. The nuTravel 176 could allow easy onboarding for travel managers and provide multiple options that allow the easiest path for travel managers to onboard travelers. When the traveler joins, the travel manager could get their name and e-mail address that they joined with. Travelers are also accepting their travel manager(s) will have visibility into all of their booking that are made directly with the airlines.

At another stage, the travelers join and the travel managers could view the traveler's details who are joined the company's system account. As travelers join the company, the travel manager will be able to view which travelers have joined. They can assign them to a different team and get information about the traveler. They can also change their role, from traveler to Admin or Arranger. In one embodiment, the nuTravel 176 could enable the travel managers to view the travelers who are joined in the system 100 and make it easy to travel managers to move travelers into different groups. When the travelers joined, the travel manager will be able to get the travelers details such as name and e-mail address they used to sign up with (usually a corporate email address) the system 100. The data related to travelers such as name and e-mail could be accepted and stored in the system's database and company affiliations.

In one embodiment, the system 100 is further configured to send invitations for agencies. At one stage, the user could login into the system 100 (Universal connect) using credentials such as user ID and password. The user could connect the agency so that they can view the travelers and their bookings with airlines. Travel managers could send an invitation to their travel agency in order for that travel agency to gain limited access to their system's account. Travel agencies will be able to view travelers as well as their booking that were made directly with the airlines. In one embodiment, the nuTravel 176 could provide travel managers an easy way to give their travel agency visibility into their system's (UC) account in order for the travel agencies agents to view and service their bookings. Travel managers could invite agencies by entering an email address. An email is triggered by the system (UC) 100 to that e-mail address with a unique link to accept their invitation. The data and the e-mail address that was sent to are accepted and stored within the system's database.

Another stage, the agencies could join and the travel managers could get notified when agencies accepted the invitation also able to check the agencies those are not accepted the invitation. When an agency accepts the invitation, the travel manager will check that the agency accepted and can revoke access at any time. The agency will go on to invite travel agents to the agency who will have access to the connected companies' bookings and traveler information. The travel manager could successfully invite one or more travel agencies. Agency Administrator successfully accepts the invitation and creates an account or uses an existing UC account to accept the company's invitation. Travel manager will be able to check the travel agency that joined as well as their ARC/IATA number. In one embodiment, the travel agency details such as name, address, phone number, e-mail, and as well as ARC/IATA number are accepted and stored within the system's database. In one embodiment, the ARC/IATA number is transmitted to a TBD third party service to verify the agency is legitimate and the number belongs to the agency.

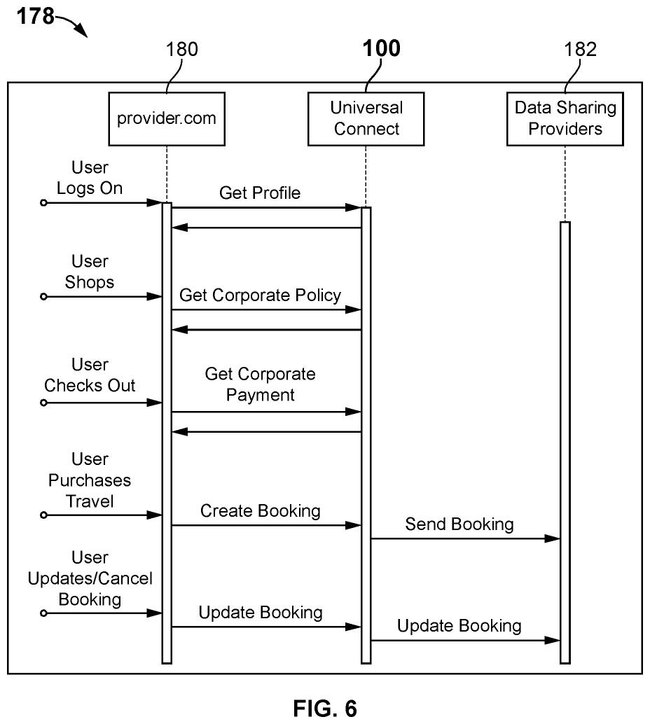

Referring to FIG. 6, a schematic diagram of an application programming interface (API) flow 178 in one embodiment is disclosed. In one embodiment, the user could log in or sign in into the system 100 (Universal Connect) to access the user profile associated with their account. The user profile includes declarative information about the user that was explicitly shared by the user. In one embodiment, the user or service providers (provider.com) 180 are connected to the system 100 (Universal Connect) via an API gateway. The API gateway is configured to perform various functions such as, but are not limited to, user authentication and also transfer and receive data related to profiles, corporate policies, corporate payments, etc. from the system 100 (Universal Connect).

In one embodiment, the user could get a corporate policy from the system 100 (Universal Connect). In one embodiment, the user or travel providers could check the corporate payments by connecting to the system 100 (Universal Connect) via the API gateway. In one embodiment, the user could purchase travel tickets and create travel bookings. The information related to travel bookings could be sent to data sharing providers 182. In one embodiment, the user could enable to update and/or cancel the created travel bookings by connecting to the system 100 (Universal Connect). Further, the information related to travel bookings could be sent to the data sharing providers 182.

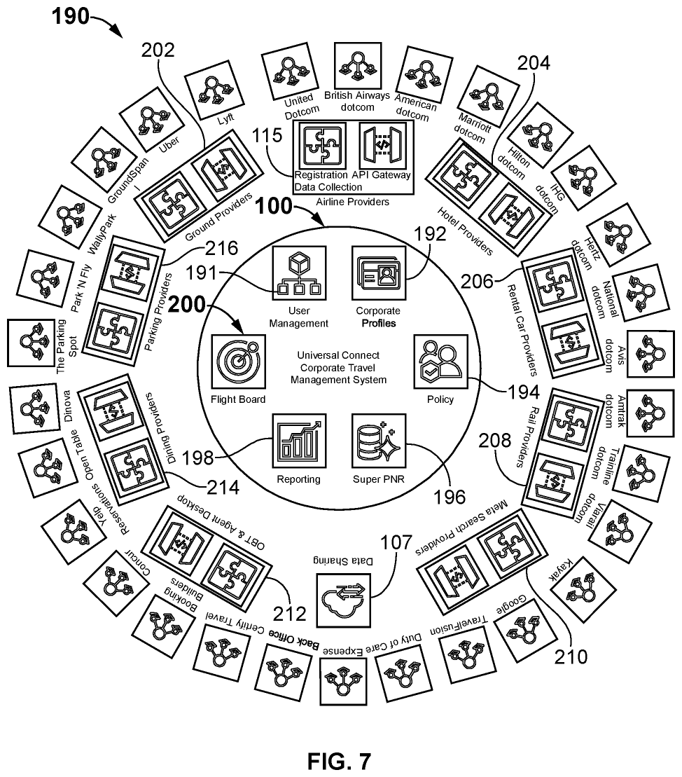

Referring to FIG. 7, a schematic diagram of the system 100 with service providers in one embodiment is disclosed. In one embodiment, the system 100 further comprises a user management 191, corporate profiles 192, policy 194, super PNR 196 (combined trip view with reservations from multiple travel providers for a single trip), reporting 198, and a flight board 200. In one embodiment, one or more service providers are connected to the system 100 via an API gateway. In one embodiment, the service providers include, but not limited to, airline providers 115, ground providers 202, hotel providers 204, rental car providers 206, rail providers 208, meta search providers 210, OBT & agent desktop 212, dining providers 214, and parking providers 216.

In one embodiment, the airline providers 115 include, but not limited to, United airlines, British airways, and American airlines. In one embodiment, the ground providers 202 include, but not limited to, GroundSpan, Uber, and Lyft. In one embodiment, the hotel providers 204 include, but not limited to, Marriott, Hilton, and IHG. In one embodiment, the rental car providers 206 include, but not limited to, Hertz, National, and Avis, and rail providers 208 include, but not limited to, Amtrak, Trainline, and Viarail. In one embodiment, the meta search providers 210 include, but not limited to, kayak, Google, and TravelFusion. In one embodiment, the data sharing module 107 is configured to share or transfer data to one or more expense providers, duty of care (DoC), and also back office. In one embodiment, the OBT & agent desktop 212 includes, but not limited to, certify travel, booking builders, and concur and the dining providers 214 include, but not limited to, Yelp Reservations, open table, and dinova. In one embodiment, the parking providers 216 include, but not limited to, Theparking spot, ParkN Fly, and WallyPark.

In one embodiment, a method used for a traveler to join and sign up via an invitation to access the system 100 is disclosed. At one step, the traveler could accept the invitation or self-enroll through a shared link or via an e-mail address. At another step, the traveler could sign up or sign in with the existing account to join a particular company that is invited or otherwise could join with the e-mail address. Travelers can join by accepting the e-mail invitation, clicking on a shared link or by coming to the system (UC) web site and entering in their corporate e-mail address to find matching companies. In one embodiment, the traveler can join one or more companies. At another step, the nuTravel 176 allow easy onboarding for the travelers. When the traveler joins, the travel manager could get their name and e-mail address that they joined with. Travelers could accept that their travel manager(s) will have visibility into all of their booking that are made directly with the airlines. In one embodiment, the basic information such as traveler's name, e-mail address, and password are accepted and stored within the system's database. In one embodiment, the travelers corporate e-mail address is transmitted to travel providers and third-party data companies that the travel manager has opted into.

In one embodiment, the method used for travelers to link their personal loyalty accounts to each travel provider for each company at one stage is disclosed. At one step, the traveler could login into the system 100 using the UC credentials such as user name and password. At another step, the traveler could select a company and check the list of the participating travel providers (for example, airlines, etc.) that they can link with. At another step, the traveler could check and link to the travel providers that are used for the business travel. Travelers link their personal loyalty accounts to each travel provider for each company they belong to. This establishes the link between the traveler and the airline or other travel provider so that, when they sign in with their loyalty account with the airline they will be recognized as a traveler for that particular company. At another step, the nuTravel 176 provides an easy way to link multiple travel providers quickly for the travelers and also enable the travelers to check which travel providers are they connected. Travelers will only be able to link to the travel providers that the travel manager has activated on the company's UC account. The travel will authorize this connection directly with the airline by signing in with the airline's loyalty credentials. In one embodiment, the loyalty account information such as user name, e-mail, phone number, and password are accepted by the system and also transmitted to the airline. Travelers loyalty number for the provider and the airline stores the link between the traveler and the company is stored within the system's database.

In one embodiment, the method used for travelers to link their personal loyalty or user accounts for each travel provider for each company at another stage is disclosed. At one step, the traveler could directly check the airlines website (for example, airline.com). At another step, the traveler could sign in into the system 100 with the linked loyalty account and check for booking personal or business trip. At another step, the traveler could directly book a business trip by checking the available airlines. When the traveler links their loyalty account to their business traveler UC account, they can go directly to the airline's website to book for a business trip. They will sign in and check the option to book for a business trip. They will get corporate pricing on trips, view their travel policy and able to pay for the trip with a payment method provided by the corporate admin. In one embodiment, the nuTravel 176 could enable the traveler to create a booking on the airline's website. Traveler can check corporate rates, travel policy, and corporate forms of payment provided by their travel manager through UC account. At another step, Full itinerary data could be sent to the traveler by the airline or travel provider. Further, at another step, the data could send to the travel provider that can include company and traveler information (loyalty number, company name, travel policy, payment cards) and also transmit data that is received to third party data providers that the travel manager has activated on the system 100 (universal connect).

In one embodiment, a method used for an agency to join and sign in for accessing the system 100 at one stage in one embodiment is disclosed. At one step, the agency could accept the invitation sent by the travel manager. At another step, the agency could sign up or sign in with the existing UC agency admin account. At another step, the agency admin could easily accept the invitation by a company. Agencies are made up of agency admins and agents. An agency admin can accept an e-mail invitation by a company to link that company to the agency. Once an agency is linked, all of the agents for that company will have access to the company's travelers (name and e-mails) as well as all of the trips that were booked (trip details and can link to the travel providers website to manage the trips). In one embodiment, the nuTravel 176 could enable the travel manager to invite the travel agency and also enable the travel agency to accept the invitation. Once the travel agency is linked, all agents in that agency will be able to sign into the system 100 and check all of the trips for that company. They will be able to also go directly to the airline website to manage those trips (changes/cancels). Further, at another step, the travel agency has to provide an ARC/IATA number for verification in order to join and access the system 100.

In one embodiment, a method used for inviting agents by the travel agency at one stage in one embodiment is disclosed. At one step, the agency admin could log in into the system 100 using their credentials and select the agency. At another step, the agency admin could check the list of current agents for the agency and send e-mail invitations to new agents. At another step, the agency admin could check the existing agents and invite new ones. Agency admins can invite as many agents as they'd like to join their agency UC account. Once an agent joins, they will have visibility into the bookings for all of the companies that the agency is paired with. Agency admins can remove agents at any time. In one embodiment, the nuTravel 176 could enable the agency admin and provide an easy way to onboard travel agents. At another step, the basic information about each travel agent (for example, name, e-mail address, agency affiliation(s) could be collected and stored within the system's database. Each agent will have access to all booking data for connected companies.

In an embodiment, the at least one database may be accessible by the authentication server. In another embodiment, the at least one database may be integrated into the authentication server or separate from it. In an embodiment, the at least one database resides in a connected server or in a cloud computing service. In an embodiment, regardless of location, the at least one database comprise a memory to store and organize certain data for use by the authentication server. In one embodiment, the at least one database stores profile data of the traveler. In one embodiment, the profile data comprises email address, data identifying the user, image of the traveler, data identifying the profession of the traveler.

In one embodiment, the authentication server is at least one of a general or special purpose computer. In an embodiment, it operates as a single computer, which can be a hardware and/or software server, a workstation, a desktop, a laptop, a tablet, a mobile phone, a mainframe, a supercomputer, a server farm, and so forth. In an embodiment, the computer could be touchscreen and/or non-touchscreen device and could run on any type of OS, such as iOS™, Windows™, Android™, Unix™, Linux™ and/or others. In an embodiment, the computer is in communication with network. Such communication can be via a software application, a mobile app, a browser, an OS, and/or any combination thereof.

LIST OF FUNCTIONAL FEATURES & DESCRIPTIONS THEREOF
AS DISCLOSED IN THE ATTACHMENTS (Parts 1, 2 and 3):

| | |
|---|---|
| Activity Feed & Alerts | Areas of Universal Connect where an administrator, arranger or |
| | agent can access to view recent activity that has occurred within |
| | its company. |
| | A visual indication will ensure that the logged in user is aware |
| | that there has been unread activity. |
| | If action is required, the activity will be considered an “alert” |
| | and appear consistently across the top of the screen until the |
| | action is taken. |
| Air Policy | A policy creator and manager for administrators to set up their |
| | flight travel policy that can be applied to any airline that |
| | participates in Universal Connect. |
| | Travel Policies can be created and assigned to Teams within |
| | the company. A travel policy consists of a base policy rule and |
| | (optionally) exceptions that allow administrators to apply |
| | unique rules based on more specific travel criteria. |
| Airlines Activation | A process for administrators to activate an airline in their |
| | company. |
| | Any airline that has signed up to be part of Universal Connect |
| | will be available to all administrators to activate for their |
| | company. |
| | Airlines will be given the ability to add up to four types of |
| | program paths that a company can activate through. |
| | Administrators will choose which program their company is |
| | associated with and follow that activation process. |
| | Connection will be made once validated with the airline that |
| | the company has an existing program (if necessary) with the |
| | airline. |
| | Airline activation paths will be customizable per airline. If an |
| | airline requires a company to be approved prior to activating, |
| | they will be placed in a queue where an airline administrator |
| | will then be required to approve before the company completes |
| | the activation process. |
| Company Registration | Streamlined way to allow administrators to register a new |
| | company in Universal Connect. Once the administrator's email |
| | is validated, they will then be able to activate any active airlines |
| | in Universal Connect that they would like to make available for |
| | their travelers. |
| Corporate Admin Agency | Ability for the corporate administrator to utilize agency services |
| Settings 1 | for their company by inviting an agency to link with them. |
| | The corporate administrator will send an email invitation to an |
| | agency manager (or agent who will forward appropriately) |
| | inviting them to link to their company by filling out a simple UI |
| | with the email address of the associated user to the agency. |
| Corporate Admin Agency | Area of Universal Connect where a company administrator can |
| Settings 2 | manage and edit any settings necessary for a specific airline. |
| | These settings are specialized per the connected airline and |
| | differ from the other settings used across all airlines. |
| Corporate Payment | Ability for an administrator to add a new payment card to their |
| | company to later be assigned to be used by any team(s) within |
| | the company. |
| Duty of Care/Expense | Allows administrators to select an external duty of care provider |
| | for their company and to have booking data automatically |
| | transmitted to them by turning on a connection within the |
| | Settings area of Universal Connect. |
| Global Add/Shortcut(s) | The ability for an administrator to quickly access the areas to |
| | perform the following functions from anywhere on Universal |
| | Connect through a TBD “add” floating CTA - Invite Users, |
| | Create Team, Add Payment card, and Create Policy. |
| Global Search | Ability for an administrator, arranger or agent to search at any |
| | time, from anywhere on Universal Connection for a user or trip. |
| | Results will display directly in the search panel as the user is |
| | using the type-ahead. |
| | After clicking on the desired result, the selected will open up |
| | to the appropriate section of Universal Connect showing more |
| | details. |
| Help Center | Area where all users can access to obtain additional help on |
| | product related questions through a multitude of ways such as |
| | frequently asked questions, chat feature, help center, product |
| | tour through a third-party vendor such as Intercom. |
| Itinerary & Flight Data | This lays out the data requirements for itineraries that will come |
| | into UC from airlines and will be coupled with data from |
| | flightstats. |
| | This data will ultimately power the flightboard, reporting and |
| | data sharing to expense and duty of care providers (+others in |
| | the future). |
| List Views (Travelers, | The organizational view for administrators, arrangers and |
| Pending, Invited, Filters) | agents when accessing the People page where they will be able |
| | to see active, invited and pending members of their company in |
| | addition to members of a specific Team. |
| | Additional actions can be performed within this section as |
| | well as navigating to more details and settings for teams and |
| | people. |
| Security Assertion Markup | The ability to allow users to sign in or up for Universal connect |
| Language (SAML) or | through Single Sign On (SSO) or Security Assertion Markup |
| Single Sign On (SSO) | Language (SAML) through OKTA (or another connect |
| | provider). |
| | This allows users to use one set of credentials registered |
| | through OKTA (or another connected provider) to link with |
| | Universal Connect. |
| Team Bookings | View of trips booked by members of a specific team. |
| | The view will be located within the Team details page as a |
| | means to filter out any trips booked by specific members of that |
| | team only for an administrator, arranger or agent to see. |
| | The primary purpose for this view is to show who is booking |
| | within a team opposed to observing the activity that can be |
| | found on Tripboard. |
| Teams and Workspaces | Designation to organize users of a company within |
| | distinguished teams or workspaces to assist with the |
| | management of the company. |
| | Workspaces will be an additional feature available for the |
| | administrator to group multiple teams and to further organize |
| | the company. |
| | Teams will be the main organizational feature to group users |
| | together. |
| | Each company will have an automated, mandatory Team and |
| | Workspace. |
| Travel Agency | Access and permissions granted for agents and agencies to |
| (Create/Manage/Invites) | utilize Universal Connect on behalf of companies they have |
| | been invited to be part of. |
| | Agencies will be where agents are managed and added as well |
| | as who can accept invites with a separate UI within Universal |
| | Connect. |
| Traveler Access Settings | Travel Access Settings is where administrators will go to set up |
| | additional restrictions around who can register as a user for the |
| | company that self-registration or an invitation link. |
| | The Traveler Access settings will be dictated by one or both of |
| | the following settings: Email Domain or Requires Approval. |
| | When these settings are utilized, they will be enabled for the |
| | entire company, not just a specific team(s). |
| | In order for users to register through self-registration, the |
| | email domain setting must contain at least one domain in order |
| | for the user to be recognized to which company he/she is able to |
| | join. |
| Trip Details | Area within Universal Connect that will provide administrators, |
| | arrangers or agents with complete details of an entire trip that |
| | can be a combined list of reservations from multiple travel |
| | providers. |
| | This will show these combined travel bookings in a singular |
| | view. It may show, but not limited to, single carrier air |
| | bookings, combination of flights across multiple carriers, or |
| | additional travel types such as hotel and ground. It can be linked |
| | by an individual flight in Tripboard, a booking in Team Trips or |
| | from a specific Users trip list. |
| User Airline Linking | The process gives registered users the ability to link an airline |
| | to their user profile and link their loyalty number once the |
| | airline has been activated by an administrator to their Universal |
| | Connect company. |
| Add/Move User | Diverse, simplified methods to allow an administrator to invite |
| | other employees of their company to join Universal Connect. |
| | Adding or moving a user can be prompted within the add |
| | shortcut or directly within a Team page. |
| | The multiple ways to add users to a company will be through |
| | an invitation link or email invitation. |
| | Existing users may be added to an existing team directly by an |
| | administrator utilizing the add to modal. |
| User Registration | Diverse, simplified methods to allow an administrator to invite |
| | other employees of their company to join Universal Connect. |
| | Adding a user can be prompted within the People page or |
| | directly to a Team page. |
| | The multiple ways to add users to a company and universal |
| | connect will be through self-registration (if domain criteria is |
| | provided), invitation link or email invitation. Existing users may |
| | be added to a new team directly by an administrator utilizing |
| | the add to modal. |
| View/Edit User | Area within Universal Connect that an administrator can view |
| | and edit details of a user within their company. |
| | Arrangers and agents will have the ability to also view, but not |
| | edit, all user's profiles within the company they are given |
| | arranger rights to. |
| | The user's details will include the following: Name, Linked |
| | Airlines, Last 4 digits of loyalty#'s, Team, Workspace, Role. |
| | Users trips will also appear (upcoming and past bookings) as |
| | well as the option to send a user an email. |
| | The send email CTA will be a link to open up a new email |
| | within the user's email provider, not sent directly from our |
| | system. |

The functional features (apparatus and methods as the individual case may be) as described in the above table and as further contained, described and/or disclosed in the Attachments (Parts 1, 2 and 3) filed herewith are hereby fully incorporated by reference.

Preferred embodiments of this invention are described herein (and in the attachments), including the best mode known to the inventors for carrying out the invention. It should be understood that the illustrated embodiments are exemplary only and should not be taken as limiting the scope of the invention.

The foregoing description and the attachments hereto comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented method for a universal-connect travel management system allowing a corporate travel manager to automatically capture, track and control the budget of corporate travelers, while also enabling travel service providers to allow the corporate travelers to directly book their travel arrangements, the method comprising the steps of:
registering an account for a corporate traveler to access the travel management system;
sending an invitation to the corporate traveler, via a web-link or an e-mail, for the corporate traveler to select at least one travel service provider;
activating the at least one service provider in the management system utilizing specific data;
authenticating, for the corporate traveler, at least one travel program of the at least one travel service provider;
connecting the at least one travel program of the at least one travel service provider to at least one of an expense provider, a duty of care (DoC) center, and a travel management center (TMC);
receiving a determination from the at least one expense provider, DoC center, and TMC of whether the at least one travel program of the at least one travel service provider conforms to a corporate travel policy;
communicating to the at least one travel service provider whether a travel inventory conforms to the corporate travel policy and, authorizing the corporate traveler to directly book travel arrangements with the at least one travel service provider.

2. The computer-implemented method according to claim 1, further comprising the steps of:
creating at least one group for at least one of the at least one service provider and the corporate traveler;
adding a corporate payment method to the at least one group; and,
assigning a travel policy to the at least one group.

3. The computer-implemented method according to claim 1, further comprising the step of:
communicating to the at least one travel service provider information regarding at least one of a company information, the at least one travel service provider information, the corporate traveler information, and the service provider information for that traveler, thereby allowing the at least one service provider to customize the travel booking experience for the corporate traveler.

4. The computer-implemented method according to claim 1, further comprising the steps of:
notifying the corporate travel manager of the direct booking made by the corporate traveler; and,
allowing the corporate travel manager to view and manage the direct booking made by the corporate traveler.

5. The computer-implemented method according to claim 1, wherein the specific data utilized in the step of activating the at least one service provider in the management system comprises at least one of: a corporate customer number, a corporate contract, a loyalty program terms and conditions, and other information used to identify and, in some cases, authenticate the service provider.

6. The computer-implemented method according to claim 1, wherein the step of authenticating a travel program of the at least one travel service provider utilizes data such as the corporate traveler's loyalty program information.

7. The computer-implemented method according to claim 1, further comprising the step of:
sending an invitation for at least one travel agency to enable the at least one travel agency to view the booking of the corporate traveler with the at least one service provider.

8. The computer-implemented method according to claim 1, wherein the at least one travel service provider comprises at least one of:
an airline, a car-service agency, a rental-car agency, a rail-service, a hotel, a travel search provider, an OBT & agent desktop, a dining provider, and a parking provider.

9. The computer-implemented method according to claim 1, wherein the corporate traveler and the at least one the service provider are connected to the management system via an application program interface (API) gateway.

10. The computer-implemented method according to claim 1, further comprising the step of:
providing travel advisories to the corporate traveler; and,
providing reporting functionality to the corporate travel manager.

11. An apparatus for a universal-connect travel management system allowing a corporate travel manager to automatically capture, track and control the budget of corporate travelers, while also enabling travel service providers to allow the corporate travelers to directly book their travel arrangements, the apparatus comprising:
a processor;
a database, in communication with the processor, configured to store data related to the corporate travel manager, the corporate traveler, the travel service provider, and a travel program;
at least one module, executed by the processor and utilizing the data stored in the database, comprising at least one of a login module, an application program interface (API) module, a data-sharing module, and an admin module, and
wherein execution of the login module enables creation of an account on the travel management system for the corporate traveler, and connection of the travel service providers and the travel programs with the corporate traveler's account,
wherein execution of the API module enables the corporate traveler to book directly with the travel service provider,
wherein execution of the data-sharing module enables the travel service providers to allow the corporate traveler to directly book the corporate travel, and,
wherein execution of the admin module enables the corporate travel manager to track, analyze and control the budget of the corporate traveler.

12. The apparatus of claim 11, the log-in module is configured to send an invitation to the corporate traveler, thereby enabling the corporate traveler to create the account.

13. The apparatus of claim 11, wherein the data related to the corporate traveler are collected when corporate traveler accepts an invitation, and comprises information such as a name, an e-mail address, a phone number and an employee number.

14. The apparatus of claim 11, wherein the corporate administrator performs management activities of the company in the system and creates groups for the service providers and add corporate credit cards and travel policies then assigning them to travelers.

15. The apparatus of claim 11, wherein the admin module further enables the corporate travel manager to authorize the travel service provider to collect data comprising: a corporate customer number, a corporate contract, a loyalty program information used to identify and, in some cases, authenticate the company.

16. The apparatus of claim 11, further comprising:
an intuitive travel management interface for companies of different sizes.

17. The apparatus of claim 16, wherein the intuitive travel management interface comprises a corporate activation for a corporation to connect to the travel management system and a custom program registration process for the corporation to connect the at least one service provider.

18. The apparatus of claim 11, wherein the at least one travel service provider comprises at least one of:
an airline, a car-service agency, a rental-car agency, a rail-service, a hotel, a travel search provider, an OBT & agent desktop, a dining provider, and a parking provider.

19. The apparatus according to claim 11, wherein the corporate traveler and the at least one service provider are connected to the travel management system via an API gateway.

20. The apparatus of claim 11, wherein the data-sharing module enables the provision of travel advisories to the corporate traveler, and, the admin module further enables reporting functionality to the corporate travel manager.
